(19) United States
(12) Patent Application Publication
(10) Pub. No.: US 2026/0075156 A1
(43) Pub. Date: Mar. 12, 2026

(54) IMAGE PROCESSING METHOD AND IMAGE PROCSESING DEVICE WITH OBJECT DETECTION

(71) Applicant: Novatek Microelectronics Corp., Hsinchu (TW)

(72) Inventor: Hsiao-En Chang, Hsinchu City (TW)

(73) Assignee: Novatek Microelectronics Corp., Hsinchu (TW)

(21) Appl. No.: 18/830,626

(22) Filed: Sep. 11, 2024

(51) Int. Cl. H04N 1/60; G06V 10/56; G06V 10/60; G06V 10/75

(52) U.S. Cl. CPC H04N 1/6008; G06V 10/56; G06V 10/60; G06V 10/751; G06V 2201/07

(57) ABSTRACT

An image processing method and an image processing device are proposed. The method includes to receive an input image including multiple patches in RGB color space, compute a difference of pixel values among a first pixel and neighboring pixels thereof in a first patch among the patches with respect to each of RGB channels, determine a first color channel among the RGB channels having a maximum difference of the pixel values for the first patch, process the first patch according to the maximum difference of the pixel values for the first patch in the first color channel to generate a processed first patch, and generate an output image including the processed first patch.

### TECHNICAL FIELD

The disclosure relates to an image processing technique with object detection.

### BACKGROUND

Motion estimation and motion compensation are intensity-based and solely rely on the brightness or luminance channel (more commonly known as the Y channel) due to memory and bandwidth constraints. However, such approaches perform poorly on objects with vivid saturated color appearances and result in edge discontinuity and detail loss issues.

### SUMMARY OF THE DISCLOSURE

To solve the aforesaid issues, an image processing method and an image processing device are proposed.

According to one of the exemplary embodiments, the image processing method includes to receive an input image including multiple patches in RGB color space, compute a difference of pixel values among a first pixel and neighboring pixels thereof in a first patch among the patches with respect to each of RGB channels, determine a first color channel among the RGB channels having a maximum difference of the pixel values for the first patch, process the first patch according to the maximum difference of the pixel values for the first patch in the first color channel to generate a processed first patch, and generate an output image including the processed first patch.

According to one of the exemplary embodiments, the image processing device includes a memory and a processor. The processor is configured to receive an input image including multiple patches in RGB color space, compute a difference of pixel values among a first pixel and neighboring pixels thereof in a first patch among the patches with respect to each of RGB channels, determine a first color channel among the RGB channels having a maximum difference of the pixel values for the first patch, process the first patch according to the maximum difference of the pixel values for the first patch in the first color channel to generate a processed first patch, and generate an output image including the processed first patch.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of an image processing device in accordance with an exemplary embodiment of the disclosure.

FIG. 2 illustrates a flowchart of an image processing method in accordance with an exemplary embodiment of the disclosure.

FIG. 3 illustrates a first patch of an input image in accordance with an exemplary embodiment of the disclosure.

FIG. 4 illustrates a present relationship between gain values and maximum differences of pixel values within a patch in accordance with an exemplary embodiment of the disclosure.

FIG. 5 illustrates images throughout the image processing method in accordance with an exemplary embodiment of the disclosure.

FIG. 6 illustrates a scenario of the image processing method in accordance with an exemplary embodiment of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

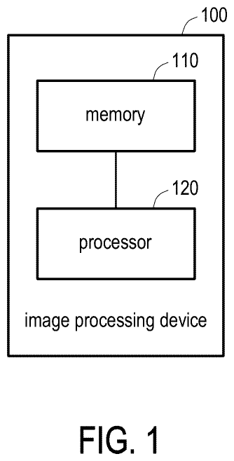

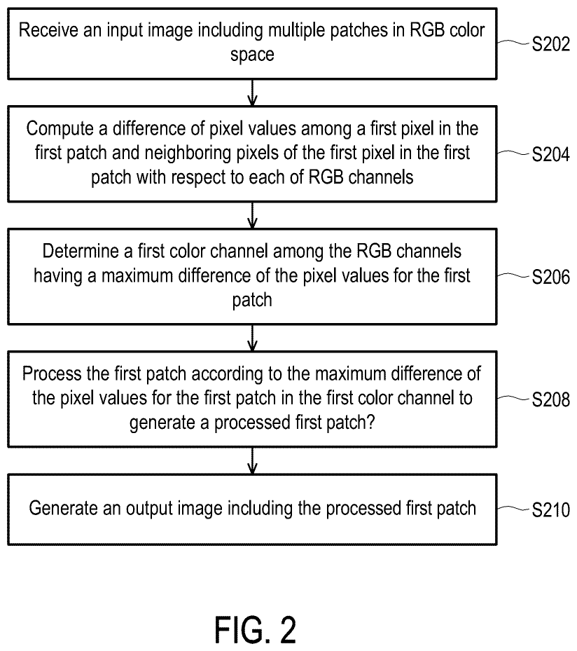

FIG. 1 illustrates a schematic diagram of an image processing device in accordance with an exemplary embodiment of the disclosure. All components and configurations of the device are first introduced in FIG. 1. The functionalities of the components are disclosed in more detail in conjunction with FIG. 2.

Referring to FIG. 1, an image processing device 100 would at least include a memory 110 and a processor 120. The image processing device 100 may be an electronic system or a computer system. The memory 110 may be many forms of random-access memory (RAM) such as a dynamic random-access memory (DRAM). The processor 120 may be one or more of a North Bridge, a South Bridge, a field programmable array (FPGA), a programmable logic device (PLD), an application specific integrated circuit (ASIC), other similar devices, or a combination thereof. The processor 120 may also be a central processing unit (CPU), a programmable general purpose or special purpose microprocessor, a digital signal processor (DSP), a graphics processing unit (GPU), other similar devices, or a combination thereof.

FIG. 2 illustrates a flowchart of an image processing method in accordance with an exemplary embodiment of the disclosure, where the steps of FIG. 2 could be implemented by the image processing device 100 as illustrated in FIG. 1.

Referring to FIG. 2 in conjunction with FIG. 1, the processor 120 of the image processing device 100 would receive an input image including multiple patches in RGB color space (Step S202). In one scenario, the input image may be a frame from a game stream or a video stream. In another scenario, if the game stream or the video stream is originally coded in another color space (e.g. YUV/YCbCr color space), the input image may be a resultant of a raw image from the stream subjected to color space conversion. Note that the input image would be divided into multiple patches (e.g. each 3×3 pixel patch) and processed patch-wisely. For illustrative purposes, only one patch (referred to as “first patch”) among the patches in the input image would be presented hereinafter, and other patches may be deduced in a similar fashion.

Next, the processor 120 would compute a difference of pixel values among a first pixel in the first patch and neighboring pixels of the first pixel in the first patch with respect to each of RGB channels (Step S204) and determine a first color channel among the RGB channels having a maximum difference of the pixel values for the first patch (Step S206). From another perspective, the first patch would exhibit a prominent dissimilarity between pixels in the first color channel, and different objects could be easier to be identified from the first patch in the first color channel than the other channels.

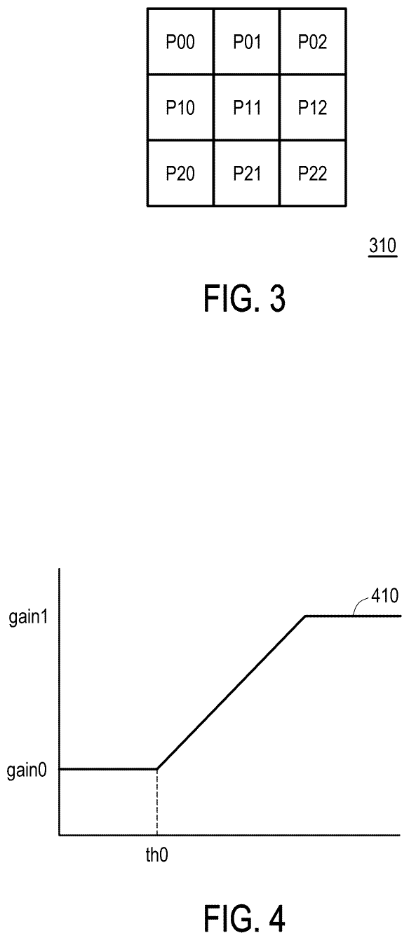

In one exemplary embodiment, the difference of pixel values among the first pixel and its neighboring pixels in the first patch with respect to each of the RGB channels may be computed by the sum of absolute differences (SAD) technique. For example, FIG. 3 illustrates a first patch of an input image in accordance with an exemplary embodiment of the disclosure.

Referring to FIG. 3 in conjunction with FIG. 1, a first patch 310 includes 9 pixels (P00, P01, P02, P10, P11, P12, P20, P21, and P22) in a 3×3 grid, where each pixel has pixel values in RGB channels. Assume that the center pixel P11 is the first pixel. The processor 120 may compute a sum of an absolute difference of pixel values between the center pixel and each of the neighboring pixels for each of the RGB channels as follows:

$$R\_diff = {\sum }_{i = 0}^{2} {\sum }_{j = 0}^{2} \vert R 11 - Rij \vert$$

$$G\_diff = {\sum }_{i = 0}^{2} {\sum }_{j = 0}^{2} \vert G 11 - Gij \vert$$

$$B\_diff = {\sum }_{i = 0}^{2} {\sum }_{j = 0}^{2} \vert B 11 - Bij \vert$$

R11, G11, and B11 denote the pixel values of the center pixel P11 respectively for the RGB channels. Rij, Gij, and Bij denote the pixel values of the neighboring pixels of the center pixel P11 respectively for the RGB channels.

Next, the processor 120 may determine the first color channel having a maximum difference of the pixel values for the first patch as follows:

$$Max Diff = max ( R\_diff , G\_diff , B\_diff )$$

For example, assume that MaxDiff is R_diff, then the first color channel would be the R channel.

Referring back to FIG. 2, the processor 120 would process the first patch according to the maximum difference of the pixel values for the first patch in the first color channel to generate a processed first patch (Step S208) and generate an output image including the processed first patch (Step S210). In one exemplary embodiment, the pixel values for the first patch in the first color channel may be enhanced by a gain value. Such gain value may be determined based on the maximum difference of the pixel values for the first patch according to a preset relationship stored in the memory 110.

For example, FIG. 4 illustrates a present relationship between gain values and maximum differences of pixel values within a patch in accordance with an exemplary embodiment of the disclosure, where maximum differences of pixel values within a patch being greater than a preset threshold th0 would have a proportional relationship 410 with gain values taken between gain0 (e.g. 0) and gain1 (e.g. 16).

Once the processor 120 determines the gain value for the first patch, the processor 120 may process the first patch according to the gain value and the pixel values of the first channel. In detail, the processor 120 may obtain intensity values of the first pixel and its neighboring pixels in the first patch and generate the processed first patch according to the intensity values, the gain, and the maximum difference of the pixel values for the first patch as follows:

$$Yout = \frac{Yin \times ( 16 - C\_coef ) + C \times C\_coef}{16}$$

Herein, Yin denotes the intensity of a pixel in the first patch (e.g. pixel value of Y channel), C denotes the maximum difference of the pixel values for the first patch, and C_coef denotes the gain value, and Yout denotes the processed pixel in the first patch.

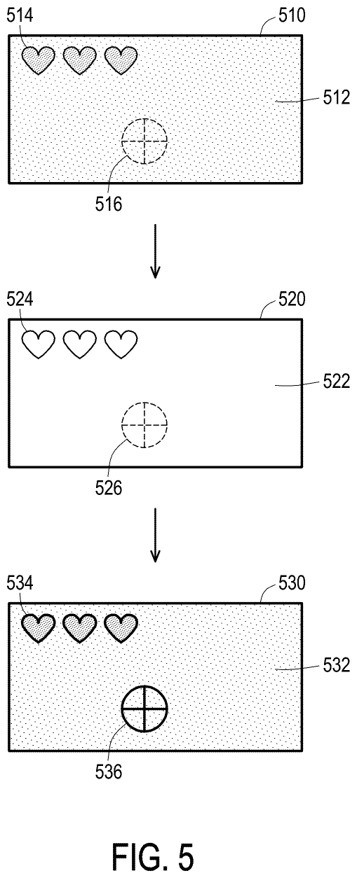

For better comprehension, FIG. 5 illustrates images throughout the image processing method in accordance with an exemplary embodiment of the disclosure.

Referring to FIG. 5, an input image 510 would be an image from a gaming stream and include a sky background 512, heart icons 514 representing health points, and a weapon crosshair icon 516. An intermediate image 520 would be an image after the maximum difference of pixel values for each patch with respect to RGB channels is identified. The maximum differences of pixel values for each patch in the input image 510 would occur at the edges of the heart icons 514 and the weapon crosshair icon 516 in the R channel and present as heart icons 524 and a weapon crosshair icon 526 in the intermediate image 520, whereas the non-edge pixels in the input image 510 would present as white (0 pixel value) in the intermediate image 520 such as a sky background 522 and the interior part of the heart icons 524 and the weapon crosshair icon 526. Next, an output image 530 with the processed patches would include heart icons 534 and a weapon crosshair icon 536 with enhancement that show prominent contrast from a sky background 532.

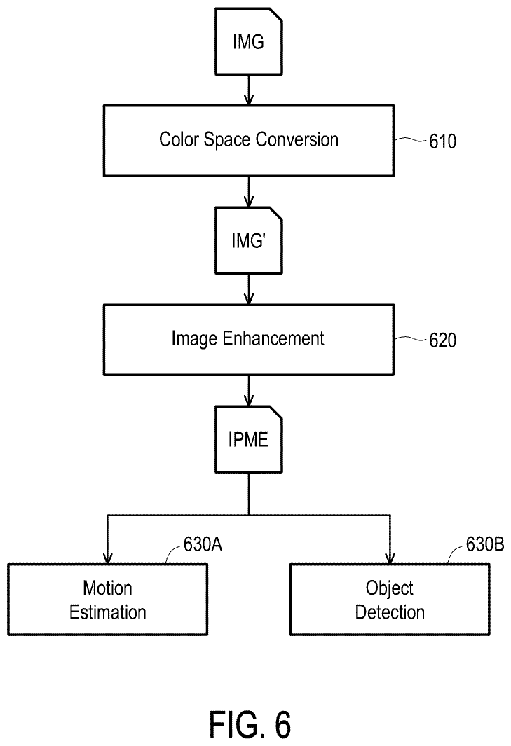

FIG. 6 illustrates a scenario of the image processing method in accordance with an exemplary embodiment of the disclosure, where the scenario of FIG. 6 could be implemented by the image processing device 100 as illustrated in FIG. 1.

Referring to FIG. 6 in conjunction with FIG. 1, the processor 120 would receive a raw image IMG in YUV/YCbCr color space from a video stream or a game stream and perform color space conversion 610 on the raw image IMG to generate an input image IMG′ in RGB color space. Next, the processor 120 would perform image enhancement 620 on the input image IMG′ based on Steps S202-S210 in FIG. 2 to generate an output image IPME (also known as “input image for motion estimation”). In terms of application, the processor 120 may perform motion estimation 630A or object detection 630B on the output image IPME. Note that the aforesaid framework can lead to visible improvement on motion estimation and object detection performance particularly on objects with vivid saturated color appearances.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for image enhancement comprising:
receiving an input image comprising a plurality of patches in RGB color space, wherein the plurality of patches comprise a first patch;
computing a difference of pixel values among a first pixel in the first patch and a plurality of neighboring pixels of the first pixel in the first patch with respect to each of RGB channels;
determining a first color channel among the RGB channels having a maximum difference of the pixel values for the first patch;
processing the first patch according to the maximum difference of the pixel values for the first patch in the first color channel to generate a processed first patch; and
generating an output image comprising the processed first patch.

2. The method according to claim 1, wherein before receiving the input image comprising the plurality of patches in the RGB color space, the method further comprises:
receiving a raw image in another color space; and
performing color space conversion on the raw image to generate the input image in the RGB color space.

3. The method according to claim 1, wherein the difference of pixel values among the first pixel in the first patch and the plurality of neighboring pixels of the first pixel in the first patch with respect to each of the RGB channels is a sum of an absolute difference of the pixel values between the first pixel and each of the plurality of neighboring pixels of the first pixel with respect to each of the RGB channels.

4. The method according to claim 1, wherein the first pixel is a center pixel of the first patch.

5. The method according to claim 1, wherein the step of processing the first patch according to the maximum difference of the pixel values for the first patch in the first color channel to generate the processed first patch comprising:
in determining a gain value according to the maximum difference of the pixel values for the first patch; and
processing the first patch according to the gain value and the pixel values of the first channel to the processed first patch.

6. The method according to claim 5, wherein the step of processing the first patch according to the gain value and the pixel values of the first channel to the processed first patch comprising:
obtaining intensity values of the first pixel and the neighboring pixels in the first patch; and
generating the processed first patch according to the intensity values, the gain, and the maximum difference of the pixel values for the first patch.

7. The method according to claim 5, wherein the gain value is proportional to a value of the maximum difference of the pixel values.

8. The method according to claim 1 further comprising:
performing motion estimation on the output image comprising the processed first patch.

9. The method according to claim 1 further comprising:
performing object detection on the output image comprising the processed first patch.

10. An image processing device comprising:
a memory; and
a processor, configured to:
receive an input image comprising a plurality of patches in RGB color space, wherein the plurality of patches comprise a first patch;
compute a difference of pixel values among a first pixel in the first patch and a plurality of neighboring pixels of the first pixel in the first patch with respect to each of RGB channels; and
determine a first color channel among the RGB channels having a maximum difference of the pixel values for the first patch;
process the first patch according to the maximum difference of the pixel values for the first patch in the first color channel to generate a processed first patch; and
generate an output image comprising the processed first patch.
